(19) United States
(12) Patent Application Publication
(10) Pub. No.: US 2022/0288432 A1
(43) Pub. Date: Sep. 15, 2022

(54) Fire sprinkler automatic extinguisher

(71) Applicant: Frank Tarsitano, Toronto (CA)

(72) Inventor: Frank Tarsitano, Toronto (CA)

(21) Appl. No.: 17/300,117

(22) Filed: Mar. 15, 2021

(51) Int. Cl. A62C 13/76; A62C 13/64; A62C 37/14

(52) U.S. Cl. CPC A62C 13/76; A62C 13/64; A62C 37/14

(57) ABSTRACT

The Fire Sprinkler Automatic Extinguisher designed and created for a quick response to the dangers of fire. My invention design & creation of the Cap Head T-Knob Handle & Nozzle Fitting allows the connection of a Fire Sprinkler Pendant, that it can automatically discharge on its own without the use of an operator. It also replaces ceiling water fire sprinkler suppression systems without the need for Pipes, Plumbing, Electrical and Water.

When the temperature of a fire reaches 155 degrees (F.), the thin glass bulb in the Fire Sprinkler Pendant head containing an alcohol liquid, boils, expands it breaks the thin glass bulb. This action releases a copper plug from Pendant and the 195-psi nitrogen gas pushes out a dry chemical agent from inside the fire extinguisher cylinder body.

A Fire Sprinkler Automatic Extinguisher can also operate manually by simply using the Hammer pin attached to Extinguisher for snapping the thin bulb glass in the Sprinkler Pendant Head. The manual operation called the PASS code method “Pin, Aim, Snap & Sweep,” at the base of the fire.

### DESCRIPTION OF INVENTION

A Fire Sprinkler Automatic Extinguisher comprising of a Cap Head T-Knob Handle, a

Nozzle Fire Sprinkler Pendant Fitting, a Ceiling Lock-In Cover Plate, a Wall Bracket, for the use in a wall or ceiling dry chemical fire sprinkler suppression system application, eliminating the need for Pipes, Plumbing, Electrical and Water.

A Fire Sprinkler Automatic Extinguisher is not a one-dimensional manual fire extinguisher. It can discharge automatically; it is not solely dependent on a user operator.

The objective of invention is, to provide a Fire Sprinkler Automatic Extinguisher for the use in a Wall or Ceiling Fire Sprinkler Suppression System. Designed with a Cap Head T-Knob Handle on/off control discharging component, Nozzle Fitting attachment for a Fire Sprinkler Pendant, including a Lock-in Ceiling Cover Plate, Wall Bracket. A Fire Sprinkler Automatic Extinguisher missing in the field of Art, which eliminates the need of user operator and replaces a water fire sprinkler suppression system.

A Fire Sprinkler Automatic Extinguisher eliminates the life-threatening burden on citizens to be fighter fires. When installed on a wall or ceiling application, it gives our brave firefighters head starts in confronting and extinguishing fires.

A Fire Sprinkler Automatic Extinguisher is a vital device for saving lives and properties. In the Field of Art, this versatile tool is missing in the Fire Protection Suppression Systems. A Fire Sprinkler Automatic Extinguisher installed on a wall or ceiling will help protect our Citizens. Especially, the most vulnerable as the Blind, Handicap, Elderly & Children who cannot operate a manual fire extinguisher. They all will have a higher chance of fire death survival because of its automatic independent quick response action in unattended fires.

A Fire Sprinkler Automatic Extinguisher will help limit the horrendous increase in fire damage claims & deaths. It will provide an effective affordable alternative to the failures and limited functions of the one-dimensional manual fire extinguishers. It also replaces Water Fire Sprinkler Systems; water is the costliest damage in expense in insurance claims.

A Fire Sprinkler Automatic Extinguisher used as a dry chemical full ceiling fire sprinkler suppression system without the need for Pipes, Plumbing, Electrical or Water that is missing in our field of Art.

### BACKGROUND OF INVENTION

In 1813, Captain John William Manby from our native country of England invented the first manual fire extinguisher solely dependent on a user operator. It has been over 208 years since any changes to modify it to perform more effectively. A Fire Sprinkler Automatic Extinguisher used in a wall or ceiling as a complete fire sprinkler suppression system without a user operator and eliminating the need for pipes, plumbing, electrical or water.

I created a Fire Sprinkler Automatic Extinguisher after a dream. I was fire blocked from reaching my manual fire extinguisher in a fire located in my basement furnace room. I watched a manual fire extinguisher burn on the wall; it was useless. Citizens are still dying in fires even though fire extinguishers were in their residential & commercial properties.

A Fire Sprinkler Automatic Extinguisher eliminates the burden on Citizens to be firefighters. It is a vital equipment tool for our Elderly, Blind, Handicap, Children and Fireman. An installed fire sprinkler automatic extinguisher in unattended areas will help us limit the deaths & costly fire damage claims. Most importantly it provides fire protection 24/7 saving lives & properties.

### SUMMARY OF INVENTION

### A Fire Sprinkler Automatic Extinguisher

A Fire Sprinkler Automatic Extinguisher is unique, used as a complete effective & affordable Fire Sprinkler Ceiling Suppression System without the need for Pipes, Plumbing, Electrical or Water.

Water is the most expensive damage in fire claims. Insurance companies and Property owners will save thousands of dollars in fire damage claims with a Fire Sprinkler Automatic Extinguisher Ceiling Application. Easy to install, simply cut a 4 ½ inch hole in existing ceiling. Turn the T-Knob Cap Head Handle clockwise to arm extinguisher in automatic mode. Slide the Fire Sprinkler Automatic Extinguisher inside the hole cavity. Center the Fire Sprinkler Pendant in center of hole. Use the Lock-in Ceiling Cover Plate and attach it flush to ceiling onto the Fire Sprinkler Pendant. There is No Pipes, Plumbing, Electrical or Water required when installing a Fire Sprinkler Automatic Extinguisher. Continue installing Fire Sprinkler Automatic Extinguisher units throughout the required coverage area for a full complete Ceiling Fire Sprinkler Suppression System.

A Fire Sprinkler Automatic Extinguisher 5lb unit has a tested UL fire coverage rating of 40 sqft although it will automatically spray coverage of up to 200 sqft. A Fire Sprinkler Automatic Extinguisher invention able to perform a secondary function with a quick response to the dangers of fires in a fire sprinkler suppression system application fills the void missing in the field of Art.

### DESCRIPTION OF DRAWINGS

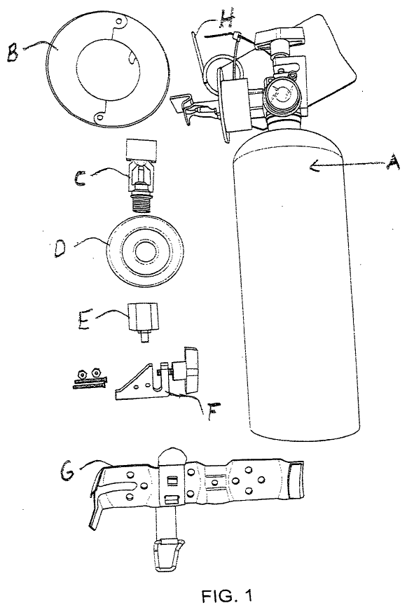

### Page 1 of 9 FIG. 1

Displays all the components used to assemble a Fire Sprinkler Automatic Extinguisher.

FIG. 1, A; Illustration is the assembled Fire Sprinkler Automatic Extinguisher. FIG. 1, B; is the Ceiling Lock-In Cover Plate used in a ceiling installation. FIG. 1, C; Is the Fire Sprinkler Pendant. FIG. 1 D; is the Escutcheon Ring Cover that protects the Sprinkler Pendant Head. FIG. 1, E; is the Nozzle Fitting to connect the Sprinkler Pendant. Male end of fitting connects to the Fire Extinguisher Body. FIG. 1, F; is the Cap Head T-Knob Handle with screws & nuts for mounting and saddling on-top of Fire Extinguisher Pin Valve. FIG. 1, G; is the Wall Bracket used to support the Fire Sprinkler Automatic Extinguisher. FIG. 1, H; Hammer Pin to manually snap bulb in Pendant to discharge Fire Extinguisher. All these components used in two installation applications of a Fire Sprinkler Automatic Extinguisher. The two applications are Wall & Ceiling installation.

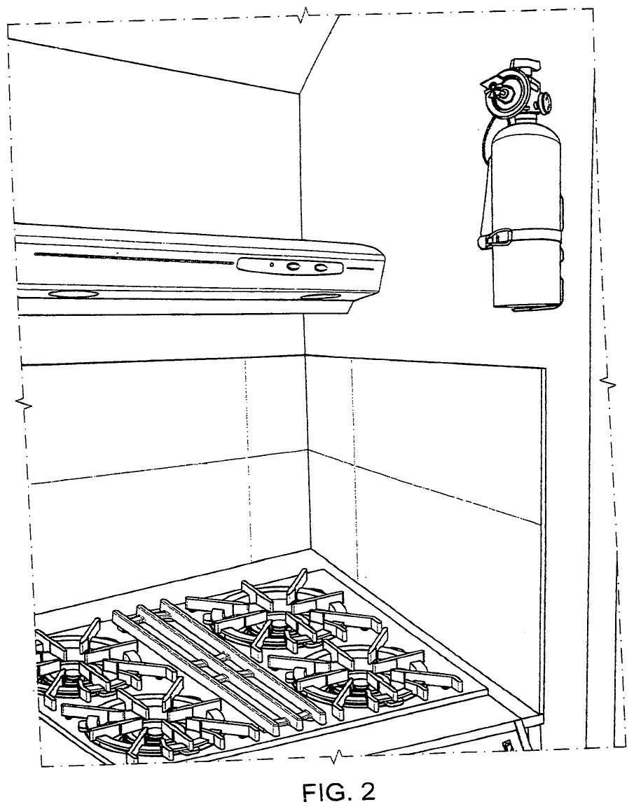

### Page 2 of 9 FIG. 2

Illustrated is the Wall installation application of a Fire Sprinkler Automatic Extinguisher. This FIG. 2 shows a kitchen wall installation whereby the fire sprinkler automatic extinguisher securely mounted using the wall bracket with locking strap at the required minimum height of 5 ft from the floor level.

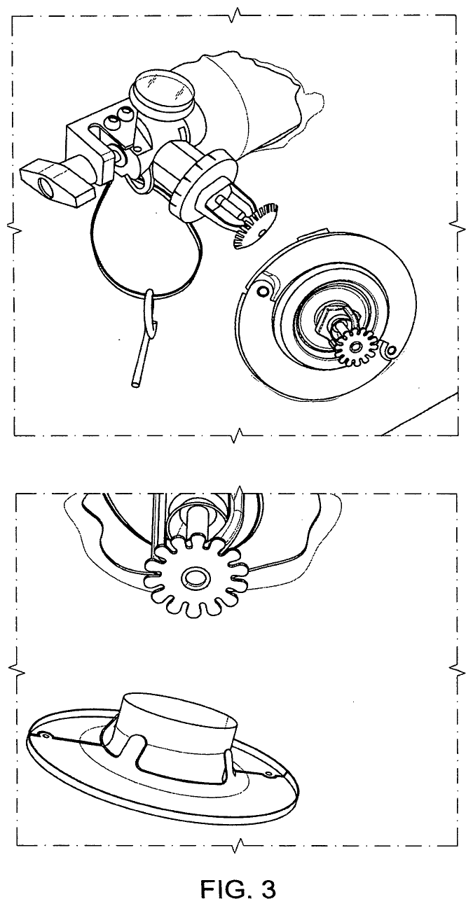

### Page 3 of 9 FIG. 3

This drawing simply shows the Ceiling Application of the concealed Fire Sprinkler Automatic Extinguisher with the proper Fire Sprinkler Pendant used for Ceiling installations applications in a Ceiling Fire Suppression System.

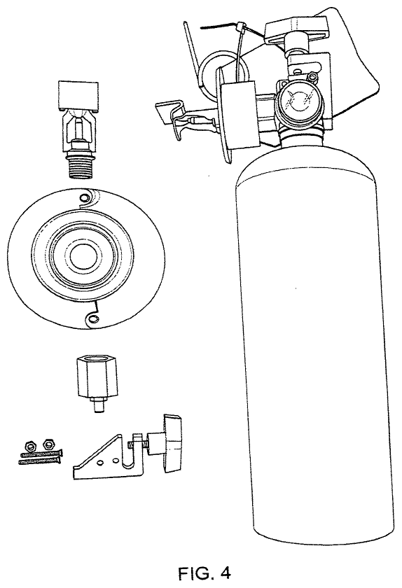

### Page 4 of 9 FIG. 4

Displayed is the Ceiling Lock-in Cover Plate attached around the Escutcheon Ring as one unit for a ceiling installation application. The Fire Sprinkler Pendant head goes through the Escutcheon Ring and then screws into the Nozzle Fitting. At the bottom is the Cap Head Handle with screws and locking nuts. These screws are to fasten the Cap Head T-Knob handle thru predrilled holes and mounts on top of the cylinder head of the Fire Sprinkler Automatic Extinguisher.

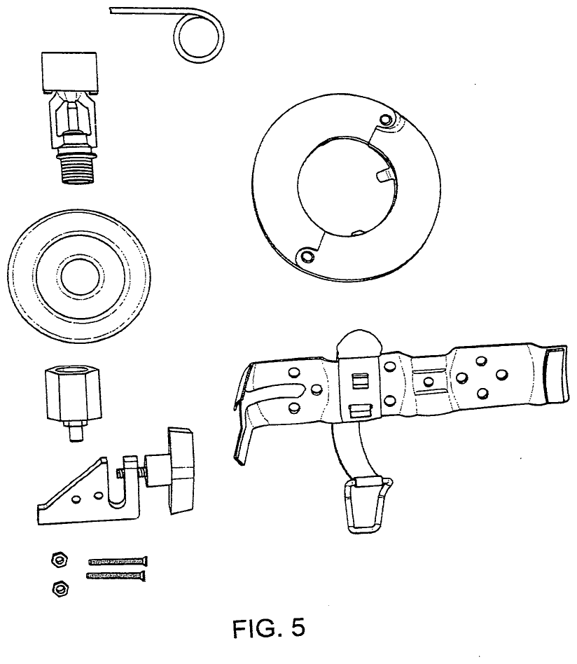

### Page 5 of 9 FIG. 5

Displays all components used for a Fire Sprinkler Automatic Extinguisher notice the Hammer Pin at the top used to snap the glass bulb in the sprinkler pendant head for manual use discharge.

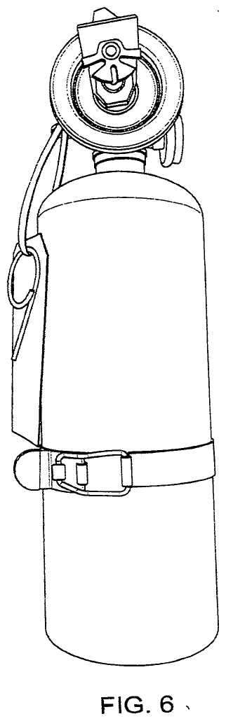

### Page 6 of 9 FIG. 6

Displays the Fire Sprinkler Automatic Extinguisher assembled, installed on a wall. Front view with bracket locking strap securely mounted to a wall to hold Fire Sprinkler Automatic Extinguisher in place.

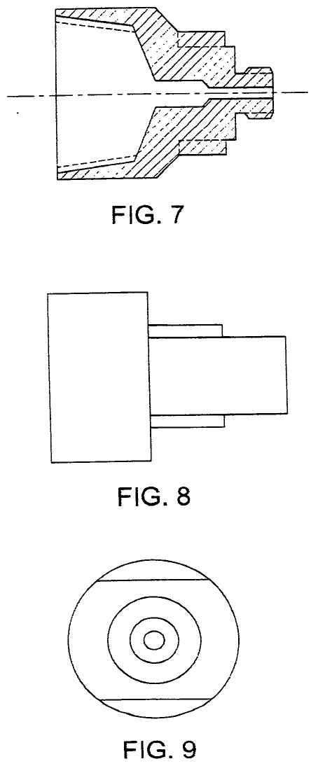

### Page 7 of 9 FIG. 7, 8, 9

Displays the Nozzle Fitting which is first of two major key components of my invention. I invented, designed & created the Nozzle Fitting so a Fire Sprinkler Pendant for the attachment to a fire extinguisher.

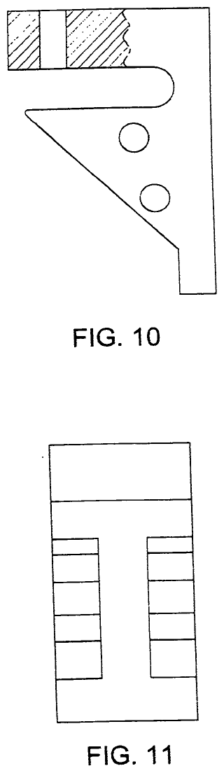

### Page 8 of 9 FIG. 10, 11

The Cap Head I invented, designed, and created is the Second Key component of my invention. The Cap Head with its T Knob Handle mounted on the top of a fire extinguisher replacing the standard squeeze handle used on all manual fire extinguishers.

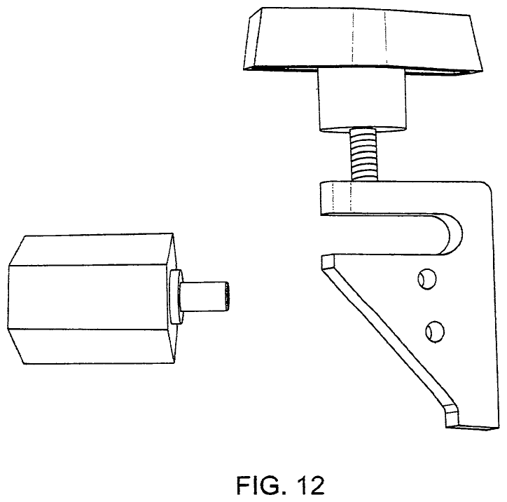

### Page 9 of 9 FIG. 12

The Invention's Key Components are the “Cap Head T-Knob Handle & Nozzle Fitting” the assembly and attachment creates the Fire Sprinkler Automatic Extinguisher.

### DETAILED DESCRIPTION OF DRAWINGS

### A Fire Sprinkler Automatic Extinguisher

### Drawing Page 1 of 9 FIG. 1

The drawing displays all the components used to assemble & install the complete Fire Sprinkler Automatic Extinguisher unit in FIG. 1, A. comprising; (F) Cap Head T-Knob Handle, (E) Pendant Nozzle Fitting, (C) Pendant, (D) Escutcheon, (B) Lock-in Ceiling Cover Plate and (G) Wall Bracket.

### Page 1, FIG. 1, H;

Shows the Hammer Pin attached to a Fire Sprinkler Automatic Extinguisher. The “Hammer Pin” used in a manual operation to snap the thin glass bulb in the Fire Sprinkler Pendant Head. This action allows the discharge of the dry chemical agent stored inside the fire extinguisher cylinder.

Page 5 FIG. 5 illustrates the Fire Sprinkler Pendant Head

The Fire Sprinkler Pendant Head has a thin glass bulb holding a copper plug that prevents the chemical dry substance from discharging inside the fire extinguisher cylinder. In an Automatic operation, the Fire Sprinkler Automatic Extinguisher discharges once the temperature heat of 155 F degree reached in an actual fire. The Fire Temperature heat boils the alcohol substance inside the glass bulb and expands until it breaks. Once broken, the copper pin plug pushes away with 195 psi stored nitrogen. This action releases a dry chemical agent inside the fire extinguisher cylinder. The attachment used to connect the Fire Sprinkler Pendant Head into the nose output of a Fire Sprinkler Automatic Extinguisher body is the Nozzle Fitting

### Page 7 of 9 FIG. 7, 8, 9.

The invention, design, and creation drawings of the Nozzle Fitting & Cap Head T-Knob Handle on Page 9 Of 9 FIG. 12 are the most important components that make a Fire Sprinkler Automatic Extinguisher function properly. The Nozzle Fitting enables a Fire Sprinkler Pendant attachment to fire extinguisher body.

### Page 9 of 9 FIG. 12A Cap Head T-Knob Handle

It is the Cap Head T-Knob Handle that puts the fire Extinguisher in Automatic mode. Turning the Cap Head T-Knob Handle clockwise screws down onto the top of the fire extinguishers release pin valve. At this point, a Fire Sprinkler Automatic Extinguisher is now in Automatic mode ready for discharging. Discharging occurs once the glass thin bulb in the Fire Sprinkler Pendant breaks. Broken by the Fire Temperature Heat or manually with the Hammer Pin. The Cap Head T-Knob can also turn the fire extinguisher discharge off by turning counterclockwise. It is a critical component that used for recharging & the filling process of a unit.

A Fire Sprinkler Automatic Extinguisher installed on or inside Wall & Ceiling Surfaces. On a Ceiling application for the use of a Fire Sprinkler Suppression System application Page 3 of 9 FIG. 3. A Fire Sprinkler. Automatic Extinguisher body concealed in the ceiling cavity. Concealing is simply drilling a ceiling hole the diameter size of the base of the extinguisher cylinder. It is then set into automatic mode and gently placed thru the ceiling hole secured with screws using the Ceiling Lock-in Cover Plate.

Page 2 of 9 FIG. 2 Fire Sprinkler Automatic Extinguisher wall installation application

Illustration of a Wall Bracket securely mounted to the wall surface using the proper screws. A Fire Sprinkler Automatic Extinguisher sits onto the Wall Bracket and secured with the locking strap. A Fire Sprinkler Automatic Extinguisher positioned minimum 5 Ft above the Floor.

The Invented concept of replacing a fire extinguishers existing squeeze handle & nozzle with my own creation of the Cap Head Handle and Nozzle Fitting for the attachment of a Fire Sprinkler Head completes my invention The Fire Sprinkler Automatic Extinguisher

1. A Fire Sprinkler Automatic Extinguisher comprising:
a Cap Head T-Knob Handle designed to fasten onto the head of a fire extinguisher body vessel cylinder used to automatically arm and disarm extinguisher for discharging a dry chemical agent contained inside the cylinder, for a wall and ceiling application in a dry chemical fire sprinkler suppression system eliminating the need for pipes, plumbing, electrical & water.

2. A Fire Sprinkler Automatic Extinguisher according to claim 1, wherein a nozzle fitting allows the attachment of a Fire Sprinkler Pendant for the required style and model needed in a Dry Chemical Fire Sprinkler Suppression System.

3. A Fire Sprinkler Automatic Extinguisher according to claim 1 or 2 wherein the device is provided with a Lock-in Ceiling Cover Plate, a Wall Bracket to secure a fire sprinkler automatic extinguisher flush to a ceiling or wall, in the application of a dry chemical fire sprinkler suppression system.

4. A Fire Sprinkler Automatic Extinguisher as hereinbefore described in reference to the accompanying drawings in patent application.
